(19) United States
(12) Patent Application Publication
(10) Pub. No.: US 2015/0144069 A1
(43) Pub. Date: May 28, 2015

(54) Systems and methods for producing soil enhancement material

(71) Applicant: Selovita, LLC, Fort Myers, FL (US)

(72) Inventors: J. Rodney Dickerson, Homer, LA (US); Valerie Vivian-Rogers, Elk Grove Village, IL (US); Gary J. Winrow, Fort Myers, FL (US); Christian Thomas Colarusso, Fort Myers, FL (US)

(21) Appl. No.: 14/554,942

(22) Filed: Nov. 26, 2014

Related U.S. Application Data
(60) Provisional application No. 61/909,246, filed on Nov. 26, 2013.

(51) Int. Cl. A01K 61/02; A01K 63/04; C05F 3/00; A01K 63/00

(52) U.S. Cl. CPC A01K 61/02; A01K 63/00; A01K 63/04; C05F 3/00
USPC 119/230

(57) ABSTRACT

A system and a process for the production of a totally organic soil enhancement material product which includes waste byproduct from fish farming operations and common soil microbiology prepared and delivered in a carefully controlled process which greatly increases plant health and growth while simultaneously reducing the need to apply synthetic chemicals for nutrients, pests and disease.

### CROSS REFERENCE TO RELATED APPLICATIONS

In accordance with 37 CFR 1.76, a claim of priority is included in an Application Data Sheet filed concurrently herewith. Accordingly, the present invention claims the benefit of priority of U.S. Provisional Patent Application No. 61/909,246, entitled “Method of Producing a Natural Liquid Soil Enhancement Material”, filed Nov. 26, 2013, the contents of which are incorporated herein by reference.

### FIELD OF THE INVENTION

The invention is directed to the field of fish farming and, in particular, to a system and methods thereof, to produce a soil enhancement material from a fish farming system.

### BACKGROUND OF THE INVENTION

Aquaculture is a known method of raising aquatic organisms in either fresh or salt water under controlled conditions and mariculture is a technique within aquaculture whereby the organisms are raised in confinement areas, whether open ocean, ponds or tanks. Fish farming is a further subdivision within mariculture whereby the organisms are raised in tanks or enclosures.

In traditional fish farming within tanks system, excretions from the animals being raised can accumulate in the water increasing toxicity. In traditional systems, water in the tank or tanks is treated by processes to remove toxic materials either directly in the tank or tanks, or the water is removed and treated and then recirculated back to the tank system.

It is known in the industry that water containing waste from fish farming operations can be used to enhance the growth rate and health of plants, from simple algae to trees, depending only upon the type of water in the environment of the specific plant species. This water contains leftover food not consumed by the aquatic species, fecal matter (which contains microbiology), the remains of individuals that die within the process, and metabolites from microbiology living within the water. The principal drawbacks in using this wastewater for commercial operations are: 1) inconsistent organic composition; and 2) high variability of the indigenous microbiology, in both composition and population. The inability to control these two variables is a barrier to widespread use of this sustainable by-product.

While harvesting wastewater is known in the prior art, there is a large inconsistency in the quality and may contain chemistry applied to the fish which then simply adds to the lack of quality chain when the wastewater is used as soil enhancement material. In the vast majority of all cases of fish farming, the water is of such a varied composition there is no substantial or sustainable market value, so it becomes a waste product which much be treated prior to release into the environment.

What is needed in the industry is a method of processing a consistently nutrient rich product from the traditional waste stream from fish farming operations that may be used as a soil enhancement material.

### SUMMARY OF THE INVENTION

Described herein is a process to overcome these barriers and produce a platform soil enhancement material that is acceptably consistent in composition, both from organic and microbiological content. This process entails a tightly controlled environment for growing a particular aquatic species and the food consumed by the species such that the byproduct wastewater has a consistent organic content. Additionally, while it is desirable to have a purely natural organic environment, without any added artificial chemicals, this is not a limiting factor if aquatic species and the use of the soil enhancement material do not preclude such added chemistry. The soil enhancement material may also be non-organic.

An objective of the invention is to have an aquatic farming system, e.g. a fish farming system, as part of the process capable of the configuration to have a total species population at different stages of growth so that the food consumed and waste materials produced, when mixed, is acceptably consistent in composition. For ease of describing the various systems and processes embodied herein, the term “fish farming” will be used, however, it is to be understood that the system applies to all aquatic organisms.

Another objective is to provide a circulation system to maintain water in the fish farm tanks within allowable fish tolerances at tolerances to promote high fish density without high fish mortality rates usually associated with traditional fish farming.

Still another objective of the invention is to provide a rapid turnover with screening, bio-filtration and disinfection with high oxygen content to reduce the stress level on the fish such that, when combined with the high quality food, results in overall growth rates of up to 100% greater than what is customarily reported in the literature.

Another objective is to provide an extremely high quality of fish flesh which may be natural organic or certified naturally organic without the potential of any chemicals, pharmaceuticals or microbiology usually associated with traditional fish farming production environments.

Still another objective of the invention is to provide a consistent mix of fish at various growth states towards harvest maturity. Such mix of fish results in producing a water environment quality that has a very consistent volume and composition of waste stream water.

Still another objective of the invention is to provide a polyculture of aquatic organisms at various growth states towards harvest maturity. A mix of organisms results in producing a water environment quality that can be tailored for specific uses and purposes, for example, for use with: crops, turf, turf grass, golf courses, ornamental, hydroponic and green house industries, etc.

Yet still another objective of the invention is to disclose a method to convert through decontamination of the waste stream water in such a way that it is suitable for use as a soil enhancement base platform material.

Yet still another objective of the invention is to disclose a method for producing fish farming environment wherein the animals have an extremely low stress level even under high population density.

Other objectives and further advantages and benefits associated with this invention will be apparent to those skilled in the art from the description, examples and claims which follow.

### BRIEF DESCRIPTION OF THE DRAWINGS

FIG. 1 is a flow diagram of the process of the instant invention.

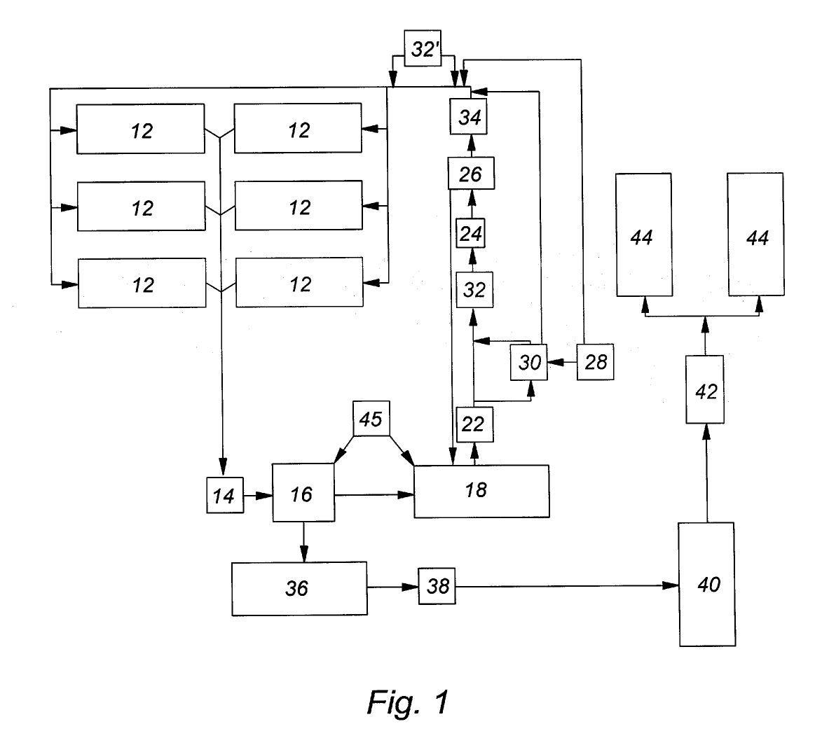

### DETAILED DESCRIPTION OF THE INVENTION

Detailed embodiments of the instant invention are disclosed herein, however, it is to be understood that the disclosed embodiment is merely exemplary of the invention, which may be embodied in various forms and is in no way intended to limit the invention, its application or uses. Therefore, specific composition ranges disclosed herein are not to be interpreted as limiting, but merely as a basis for the claims and as a representation basis for teaching one skilled in the art to variously employ the present invention in virtually any appropriately detailed composition. The embodiments of the invention may be practiced without the theoretical aspects presented. Moreover, the theoretical aspects are presented with the understanding that Applicants do not seek to be bound by the theory presented.

It should be understood that numerous specific details, relationships, and methods are set forth to provide a full understanding of the invention. One having ordinary skill in the relevant art, however, will readily recognize that the invention can be practiced without one or more of the specific details or with other methods. The present invention is not limited by the illustrated ordering of acts or events, as some acts may occur in different orders and/or concurrently with other acts or events. Furthermore, not all illustrated acts or events are required to implement a methodology in accordance with the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

### DEFINITIONS

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

As used herein, the terms “comprising,” “comprise” or “comprised,” and variations thereof, in reference to defined or described elements of an item, composition, apparatus, method, process, system, etc. are meant to be inclusive or open ended, permitting additional elements, thereby indicating that the defined or described item, composition, apparatus, method, process, system, etc. includes those specified elements—or, as appropriate, equivalents thereof—and that other elements can be included and still fall within the scope/definition of the defined item, composition, apparatus, method, process, system, etc.

The term “about” or “approximately” means within an acceptable error range for the particular value as determined by one of ordinary skill in the art, which will depend in part on how the value is measured or determined, i.e., the limitations of the measurement system. For example, “about” can mean within 1 or more than 1 standard deviation, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value. Where particular values are described in the application and claims, unless otherwise stated the term “about” meaning within an acceptable error range for the particular value should be assumed.

“Optional” or “optionally” means that the subsequently described event or circumstance can or cannot occur, and that the description includes instances where the event or circumstance occurs and instances where it does not.

“Soil” is meant to include any medium used in the germination, growth, maintenance and general health of flora. For example, the “soil” enhancement platform materials embodied herein are added to, or in place of the mineral nutrient solutions, in hydroponic cultures.

“Material”, “platform material”, “soil enhancement material”, “soil enhancement platform material”, “natural material” are used interchangeably herein and applies to the material produced by the systems and methods herein. The materials can be solid, semi-solid, liquid or any form necessary for the production, processing, storage, distribution, delivery to consumers and field application, for example, to crops, turfs, etc. The material can be used as a platform for addition of any one or more, for example: nutrients, vitamins, minerals, essential and non-essential amino acids, etc. In some embodiments, the enhancement material can be used in place of one or more, for example: nutrients, vitamins, minerals, essential and non-essential amino acids, etc. Accordingly, the composition of the platform material can be varied based on the desired end use.

“Aquatic organism” includes any organism which lives, requires or at some point their life cycle, utilize an aquatic environment. Examples include without limitation, fish, crustacean, plants, amphibians, reptiles, unicellular or multicellular organisms, invertebrates, vertebrates, animals, mammals and the like. The aquatic environment can be fresh water, brackish water or fresh water.

“Aquaculture”, also known as aqua farming, is the farming of aquatic organisms such as fish, bivalves, crustaceans, mollusks and aquatic plants. Aquaculture involves cultivating freshwater and saltwater populations under controlled conditions.

“Aquaponics”, is a food production system that combines conventional aquaculture, (raising aquatic animals such as snails, fish, crayfish or prawns in tanks), with hydroponics (cultivating plants in water) in a symbiotic environment. In normal aquaculture, excretions from the animals being raised can accumulate in the water, increasing toxicity. In an aquaponics system, water from an aquaculture system is fed to a hydroponic system where the by-products are broken down by nitrogen-fixing bacteria into nitrates and nitrites, which are utilized by the plants as nutrients. The water is then recirculated back to the aquaculture system.

“Fish farming” is the principal form of aquaculture, while other methods may fall under mariculture. Fish farming involves raising fish commercially in tanks or enclosures, usually for food. A facility that releases juvenile fish into the wild for recreational fishing or to supplement a species' natural numbers, is generally referred to as a fish hatchery. Currently the fish species most commonly used in fish farming are carp, salmon, tilapia and catfish.

“Hydroculture” is the growing of plants in a soilless medium, or an aquatic based environment. Plant nutrients are distributed via water. In basic hydroculture or passive hydroponics, water and nutrients are distributed through capillary action. In hydroponics-like hydroculture, water and nutrients are distributed by some form of pumping mechanism. The roots might be anchored in, but not limited to, for example: clay aggregate, inert medium, such as perlite, gravel, mineral wool, expanded clay pebbles or coconut husk.

“Hydroponics” is a subset of hydroculture and is a method of growing plants using mineral nutrient solutions, in water, without soil. Terrestrial plants may be grown with their roots in the mineral nutrient solution only or in an inert medium, such as perlite, gravel, mineral wool, expanded clay pebbles or coconut husk.

“Mariculture” is a specialized branch of aquaculture involving the cultivation of marine organisms for food and other products in the open ocean, an enclosed section of the ocean, or in tanks, ponds or raceways which are filled with seawater. An example of the latter is the farming of marine fish, including finfish and shellfish e.g. prawns, or oysters and seaweed in saltwater ponds.

“Polyculture” is the cultivation of two or more aquatic species or different aquatic organisms in the same environment, enclosure, tank, ponds etc. For illustrative purposes only, this may include cultivation of fish and shrimp in the same tank.

“Organic” is meant to encompass USDA Certified and naturally occurring carbon based forms usually associated with vegetation.

“Organic certification” is a certification process for producers of organic food and other organic agricultural products. Requirements vary from country to country and generally involve a set of production standards for germinating, growing, harvesting, storage, processing, packaging and shipping that include: no human sewage sludge fertilizer used in cultivation of plants or feed of animals; avoidance of synthetic chemical inputs not on the National List of Allowed and Prohibited Substances (e.g. fertilizer, pesticides, antibiotics, food additives and so forth) genetically modified organisms, irradiation, and the use of sewage sludge: use of farmland that has been free from prohibited synthetic chemicals for a number of years (often, three or more); tracking of product from seed germination to harvest; accurate labeling and notification of Certifying body; keeping detailed written production and sales records; maintaining strict physical separation of organic products from non-certified products; and undergoing periodic on-site inspections. In the U.S. the USDA and ISO Guide 65 accredited certification program would apply.

### Systems and Processes

The process comprises three parts. The first part is the aquatic organism (any organism that lives in water), e.g. fish farming process which, in the present embodiment produces any fish species, for example, Tilapia, on a monthly harvested basis. A total of about 12 growing tanks are used in this embodiment. However, it should be obvious that the number of tanks and configuration may be varied so long as the final outcome is the removal, on a daily basis, of a predetermined volume of water together with particulate matter which is removed on a continuous basis.

The farming environment comprises the grow tanks 12, an optional transfer pump 14 for use in passing water through a filter 16 for removal of suspended particulate matter to a filtered reservoir holding tank 18. In a preferred embodiment, gravity flow provides for the passing of water through a filter for removal of suspended particulate matter to a water treatment tank or in some embodiments, a filtered reservoir holding tank 18. The flow rates can vary and can be determined based on various parameters, such as, for example, the volume of the tanks, species of organisms in the tanks, number of organisms, sizes and the like.

The disclosed process separates and removes a biomass, comprised of solids, semisolids and/or some dissolved solids from the water within the fish farming system as fluid passes through the filter 16. The process filters the biomass, which is backwashed from the filter using dechlorinated potable water, from the continuously circulated fish farming water and directs the biomass to a continuously mixed solids reservoir 36 which is mixed with a predetermined portion of water from the grow tanks 12 and held for further processing.

A water treatment tank 18 or in some embodiments, a filtered reservoir holding tank 18 provides flow consistency with a transfer pump 22 or by gravity flow introducing the filtered water into a degassing apparatus 24, to remove volatile materials including ammonia. An example of a degassing apparatus 24 is a degassing tower. In one embodiment, an ozone generator fed by an oxygen concentrator 28 is inserted before the degassing unit in an amount to operate as an oxidizing agent (E°=+2.07V) to cause an immediate and significant degree of disinfection. Excess ozone is removed by the use of an ultraviolet light 32 before introduction to the degassing apparatus 24. In an alternative embodiment, the ozone generator 20, fed by the oxygen concentrator 28, is inserted after the bio-filter reservoir 26 with sufficient contact time before placement through a ultraviolet light 32′. Depending on the size of the degassing apparatus 24 and bio-filter reservoir, a transfer pump 34 may be employed to further transfer fluid.

The system comprises a bio-filter reservoir 26 containing a high surface area media to further break down suspended and dissolved organic compounds through a microbiological nitrification/denitrification process from the water. In an embodiment, fluid from the bio-filter reservoir 26 is recirculated back to the filtered reservoir/water treatment 18. Dechlorinated potable water 45 is added to makeup water lost in filtration, blending, and evaporation.

The present invention may include the addition of enriched oxygen, for example, at least about 80%, 85%, 90% or more of oxygen volume/volume (v/v) from an oxygen generator 28. The target dissolved levels in the tanks 12 are up to at least about 6 mg/l or higher of oxygen. The tanks 12 are circulated at a rate such that the entire volume of each tank is replaced every one to six hours, depending upon the growth state of the animals inside the tank.

The water in grow tanks 12 is turned over (replaced in circulation) at a rate of up to every hour which maintains the water as clear without the usual turbidity associated with traditional fish farming operations at high fish density. The clean water, rapid turnover with screening, biofiltration, disinfection and high oxygen content reduces the stress level on the fish such that, when combined with the high protein food, results in overall growth rates far exceeding that which is customarily reported in the literature. The grow tanks can use any number of tanks, tank types and tank systems.

Accordingly, in an embodiment, a method of producing a soil enhancement material comprises the steps of placing one or more aquatic species into at least one growing tank containing fluid; feeding the one or more aquatic species a formulation that is high in protein and capable of forming consistent indigenous fecal microbiology; passing the fluid from the growing tank through a screen or filter for removal of suspended particulate; directing the suspended particulate matter to a particulate reservoir holding tank and the remaining fluid to a filtered reservoir tank; mixing a predetermined portion of water from the grow tank with said suspended particulate held in the filtered reservoir tank to form an admixture; sampling of the admixture for COD, Total Nitrogen, Total Phosphorous, Total Potassium and presence of pathogens; adjusting the admixture to an acceptable value by blending additional filtered fluid amendments or other materials or additives. The amendments or other materials or additives can be added to render the admixture further conducive to growth of the added microbiology and/or plants. The admixture is decontaminated and placed into a container for shipping and distribution to suppliers and consumers. The remaining fluid is recirculated from the filtered reservoir tank to the grow tank. The screen or filter separates and removes particles, a biomass of solids, semisolids and/or some dissolved solids from the fluid having at least about a 1 to 50 μm diameter or size, at least about a 1 to 20 μm diameter or size, or at least about a 1 to 5 μm diameter or size.

The method includes the step of decontaminating the admixture by any one or more methods, comprising: pasteurization, microwaving, heating, filtration, irradiation (e.g. gamma irradiation), gassing (e.g. ethylene oxide), injecting steam, pressurizing, applying electrical energy directly to the admixture, or one or more any combinations thereof. Any methods can be utilized to create extreme temperatures or pressures to kill any microbiology, including spores.

In embodiments where the decontamination of the admixture is conducted by pasteurization, the admixture is flash heated to between about 145-185 degrees Fahrenheit (F) for less than about a minute before being immediately cooled in heat recovery unit to less than about 100 degrees Fahrenheit.

In another embodiment, a method of producing a soil enhancement material for use in growing fruits and vegetables that meet certified organic production requirements comprises the steps of: placing farm fish into at least one growing tank containing fluid; feeding the farm fish a natural or certified natural organic formulation that is high in protein; passing the fluid from the growing tank through a filter for removal of suspended particulate, the filter separates and removes a biomass of solids, semisolids and/or some dissolved solids from the fluid; directing the suspended particulate matter to a particulate reservoir holding tank and the remaining fluid to a filtered reservoir tank; mixing a predetermined portion of water from the grow tank with the suspended particulate held in the filtered reservoir tank to form an admixture; sampling of the admixture for COD, Total Nitrogen, Total Phosphorous, Total Potassium and presence of pathogens; adjusting the admixture to an acceptable value by blending addition filtered fluid; decontaminating the admixture; placing the admixture onto roots of fruits and vegetables.

Recirculating Aquaculture Systems (RAS):

Recirculating Aquaculture Systems (RAS) are intensive, usually indoor tank-based systems that achieve high rates of water re-use by mechanical, biological chemical filtration and other treatment steps. Precise environmental control means aquatic species can be cultured out with their normal climatic range, allowing operators to prioritize production goals linked to market, regulatory or resource availability criteria. For example RAS technology can be useful where ideal sites are unavailable e.g. land or water space is limiting, where water is in short supply or of poor quality, if temperatures are outside the optimum species range or if the species is exotic. It can also be employed when environmental regulation demands greater control of effluent streams and biosecurity (exclusion of pathogens and/or retention of germplasm) or where low-cost forms of energy are available. The ability to maintain optimal and constant water quality conditions can also bring animal welfare gains. Market benefits include increased ability to match seasonal supply and demand, to co-locate production with consumer/processing centers and linked to this improved traceability and consumer trust.

RAS systems are commonly characterized in terms of daily water replacement ratio (% system volume replaced by fresh water over every 24 hours) or recycle ratios (% total effluent water flow treated and returned for reuse per cycle). For a fixed water supply, increasing recycle ratios above 0% (open-flow) corresponds with an exponential increase in production capacity with greatest gains achieved at rates above 90%. By convention ‘intensive’ or ‘fully-recirculating’ RAS are typically defined as systems with replacement ratios of less than 10% per day. Conversely systems with higher replacement rates can be characterized as ‘partial-replacement’ systems. Partial replacement is commonly used to intensify rainbow trout production in raceways and tanks. Such systems require limited, often modular water-treatment installations and therefore much lower levels of capital investment compared to intensive-RAS.

Feed management is potentially greatly enhanced in RAS when feeding can be closely monitored over 24 h periods. The stable environment promotes consistent growth rates throughout the production cycle to market size—provided the operator and RAS design has taken into account the diverse range of water quality management issues. Optimum environmental conditions promote excellent feed conversion ratios (FCRs) with some high value marine species achieving market size in 50% of time taken in sea cages.

The advantages of RAS in terms of feed management assumes the operator has the capability to accurately control and record fish biomass, mortality rates and movements across the farm. Efficiency in these tasks becomes increasingly important with increasing farm size.

Due to increased growth rates and superior FCRs that can be secured in RAS farms energy savings related to feed use may partially compensate for increased energy costs associated with pumping and water purification. Exposure of stock to stress on RAS farms can be reduced for some factors such as adverse weather, unfavorable temperature conditions, pollution incidents and predation. However, fish welfare can be reduced and exposure to stressful situations increased in relation to stocking density, chronic exposure to poor water quality and associated metabolic by-products due to inadequate water treatment technology or inexperienced management. RAS operation allows full control over effluent waste, nutrient recycling into value added products with limited energy production being feasible. However, the carbon footprint generated by a closed containment facility drawing electricity, pumping in water, filtering waste, among other actions, is significant. The source of the electricity, for example, hydro-generated or coal-generated, would play a major factor in the perceived sustainability of RAS.

A key design parameter is the ratio of recycled water to waste water (more commonly quoted as percentage of recycled water in the fish tank inflow water). A useful boost to farm productivity can be achieved by recycling say 50% of the water flow and using basic solids removal and re-aeration technology for treatment. As the ratio of recycled to new water increases, more sophisticated and efficient treatment processes are required with implications for capital and operating costs. If the drivers for using RAS include biosecurity, full control over environmental conditions or minimal nutrient discharge to nearby waters, then a high ratio of recirculated to replacement water is usually required (at least 95-99%).

A related measure of water re-use is the water replacement rate, which is usually quoted in percentage of the system volume changed per day. If for instance a system has a 95% recirculated flow at a rate that effectively replaces the full volume in the tanks once per hour; then over the course of 24 hours 1.2 times the volume of the tanks will be needed in new inflow water (120% replacement rate). A 5% per day replacement rate on the same system would translate to 99.8% of the tank discharge being treated and returned to the inflow. The inverse of water replacement rate is the water retention rate, so for a replacement rate of 5% per day, the retention of water within the system would be 95% (usually referred to as the “Percent Recycle”).

In the methods embodied herein, the aquatic organisms, such as, for example, fish, shrimp, etc. are placed into at least one growing tank containing fluid. These aquatic organisms are fed with a feeding formulation that is high in protein and capable of forming consistent indigenous fecal microbiology. The fluid from the growing tank is passed through a filter for removal of particulate matter present in the fluid. The particulate matter, e.g. suspended particulate, is directed to a particulate reservoir holding tank and the remaining fluid is directed to a filtered reservoir tank.

A predetermined portion of water from the grow tank is mixed with the suspended particulate held in the filtered reservoir tank to form an admixture. This admixture is analyzed for a variety of indicators, such as, for example, COD, total nitrogen, total phosphorous, total potassium and presence of pathogens. The mixture is adjusted to an acceptable value by blending additional filtered fluid including supplements if required. The admixture is then decontaminated and placed into a container for shipping. The remaining fluid is recirculated from the filtered reservoir tank to the grow tank.

Circular Tank Outlet Flow Structures:

As described above, the tanks used for intensive fish culture can be of varied shapes and flow patterns. Tanks are designed with considerations for production cost, space utilization, water quality maintenance, and fish management. Tanks>10 m in diameter, which used to be referred to as pools, are now reasonable choices for culture systems in intensive indoor operations. Circular tanks are attractive for the following reasons: simple to maintain; “provide uniform water quality;” allow operating over a wide range of rotational velocities to optimize fish health/condition;” settleable solids can be rapidly flushed through the center drain; permit designs that allow for visual or automatic observation of waste feed to enable satiation feeding.

The water inlet and outlet structures and fish grading and/or removal mechanisms are engineered to reduce the labor requirement for fish handling and to obtain uniform water quality, rotational velocities, and solids removal within the circular tank.

The self-cleaning ability is a key advantage of circular tanks. Recommended tank diameter to depth ratios vary from about 5:1 to about 10:1. In some embodiments, a tank diameter to depth ratio varies from about 2:1 to about 20:1, or from about 5:1 to about 10:1. Even so, many farms use tanks with diameter/depth ratios as low as 3:1 and circular silo tanks use diameter/depth ratios on the order of 1:3. The flow injection mechanism can be designed to minimize tank hydraulic problems. Selection of a tank diameter/depth ratio is also influenced by factors such as the cost of floor space, water head, fish stocking density, fish species and fish feeding levels and methods. Choices of depth should also consider ease of workers handling fish within the tank and safety issues of working in waters that may be more than ‘chest’ high.

Circular tanks can approach relatively complete mixing, i.e. the concentration of a dissolved constituent in the water flowing into the tank changes instantaneously to the concentration that exists throughout the tank. Therefore, if adequate mixing can be achieved, all fish within the tank are exposed to the same water quality.

Good water quality can be maintained throughout the circular culture tank by optimizing the design of the water inlet structure and by selecting a water exchange rate so that the limiting water quality parameter does not decrease production when the system reaches carrying capacity.

The rotational velocity in the culture tank is as uniform as possible from the tank wall to the center and from the surface to the bottom, and swift enough to make the tank self-cleaning. However, it should not be faster than that required to exercise the fish. Water velocities of 0.5-2.0 times fish body length s⁻¹ are optimal for maintaining fish health, muscle tone, and respiration. Velocities required to drive settleable solids to the tank's center drain should be greater than 15-30 cm s⁻¹; for tilapia, an upper current speed of 20-30 cm s⁻¹. For salmonids, Timmons and Youngs (Considerations on the design of raceways. In: Giovannini, P. (Session Chairman), Aquaculture Systems Engineering, Proc. of World Aquaculture Society and American Society of Agricultural Engineers, 16-20 Jun. 1991, San Juan, PR (ASAE Publication 02-91). American Society of Agricultural Engineers, St. Joseph, Mich. 1991) provided the following equation to predict safe non-fatiguing water velocities:

V_{safe}<5.25/(L)^{0.37} (1)

where V_{safe} is the maximum design velocity (about 50% of the critical swimming speed) in fish lengths s−1 and where L is the fish body length in cm. In circular tanks, velocities are reduced somewhat away from the walls, which allow fish to select a variety of water velocities, as compared to raceway designs where velocities are uniform along the channel.

Circular tanks are operated by injecting water flow tangentially to the tank wall at the tank outer radius so that the water spins around the tank center, creating a primary rotating flow. The no-slip condition that exists between the primary flow and the tank's bottom and side walls creates a secondary flow that has an appreciable inward radial flow component at the tank bottom and an outward radial flow at the tank surface. This inward radial flow along the bottom of the tank carries settleable solids to the center drain and can create the self-cleaning property so desired in circular tanks.

Rotational velocity can be controlled by design of the water inlet structures, so water flow does not have to be increased beyond that required for the fish's culture environment. Current velocity in a tank can be largely controlled by varying the inlet impulse force (Fᵢ), which is defined as:

Fᵢ=ρ·Q·(ν_{orif}−νᵣₒₜₐ) (2)

where ρ is the density of water (kg m⁻³), Q is the inlet flowrate (m³ s⁻¹), ν_{orif} is the velocity through the openings in the water inlet structure (orifices or slots) (m s⁻¹), and νᵣₒₜₐ is the rotational velocity in the tank (m s⁻¹). The inlet impulse energy largely dissipates as it creates turbulence and rotation in the rotational zone. The impulse force, and thus the rotational velocity in the tank, can be regulated by adjusting either the inlet flow rate or the size and/or number of inlet openings (Tvinnereim, K., Skybakmoen, S., 1989. Water exchange and self-cleaning in fish rearing tanks. In: De Pauw, N., Jaspers, E., Ackefors, H., Wilkens, N. (Eds.), Aquaculture: A Biotechnology in Progress. European Aquaculture Society, Bredena, Belgium, pp. 1041-1047). The tank rotational velocity is roughly proportional to the velocity through the openings in the water inlet structure, especially near the tank wall, i.e.

Vᵣₒₜₐ≈α·ν_{orif} (3)

where the proportionality constant (α) is generally from 0.15-0.20, depending on the design of the inlet flow structure. The manner of flow injection influences: (i) the uniformity of the velocity profile through the tank, (ii) the strength of the secondary radial flow along the tank bottom towards the center drain (i.e. the ability of the tank to move settleable solids to the center drain), and (iii) the uniformity of water mixing. Comparison of the tank hydraulics that resulted from injecting the water flow tangentially at the outer radius of the circular tank with either: a traditional open-ended pipe point source; a short, horizontal, submerged, distribution pipe with its axis oriented towards the tank center and with evenly spaced openings along its length; a vertical submerged distribution pipe with evenly spaced openings along its length; an inlet flow distribution pipe that combines both vertical and horizontal branches.

An inlet flow distribution pipe that combines both vertical and horizontal branches (when placed somewhat away from the wall so that fish can swim between the pipe and wall, is an effective way to: (i) achieve uniform mixing, (ii) prevent short circuiting of flow, (iii) produce uniform velocities along both the tank's depth and radius, and (iv) effectively transport waste solids to the tank bottom and out the center drain.

For large circular or square tanks, e.g. diameter>6 m, placing multiple flow distribution pipes at different tank locations improves solids removal, velocity uniformity, and water quality homogeneity. However, inlet distribution pipes can interfere with fish handling. This problem can be solved by incorporating the flow distribution orifices within the tank wall, as is the case in cross-flow culture tanks. Additionally, these distribution orifices and nozzles would have to be shaped to inject the flow parallel to the tank wall and might not provide as uniform a flow distribution as that produced by placing the injection pipes away from the wall. The system is designed so that pipes can be removed during harvest or, alternatively, use of harvest methods that work around the pipes.

Circular fish culture tanks concentrate settleable solids, e.g. fecal matter, feed fines, and uneaten feed, at their bottom and center. The tank center is then continuously withdrawing settleable solids through a center standpipe that also controls water depth requires use of two concentric pipes. Perforated slots at the base of the outer pipe or a gap at the base of the outer pipe forces flow to be pulled from the bottom of the tank (capturing settleable solids) and the inner pipe is used as a weir to set the water depth within the tank.

When water depth is controlled by an external standpipe, a vertical perforated plate or screen can be used to cover the bottom center drain; this allows solids to leave the tank but excludes fish. Another method uses an annular approach plate to enhance particle entrapment. Likewise, a horizontal pipe with an annular space created by a gap between its base and the floor assists solids removal from a culture tank where water depth is controlled with an external standpipe.

Corrosion-resistant screening material, such as perforated sheets of aluminum, stainless steel, fiberglass, or plastic are used to cover drain outlets and perforated screening with horizontal oblong slots are recommended instead of holes, because the slots are easier to clean, provide greater open area, and do not clog as readily as round holes. Specific slot sizes vary depending upon the size of fish. Ideally, openings through the screen covering the center drain should be small enough to exclude fish and yet large enough not to become clogged with feed pellets or fecal matter. Entrapment of fish on the outlet occurs when fish cannot escape the area in front of the drain because the water velocity in that area is too great. Fish impingement is minimized by providing a total open area through the outlet screen so that the water velocity through the screen is ≦30 cm s⁻¹. Depending upon the species and life stage, certain situations particularly with smaller fish require water velocities≦15 cm s⁻¹, e.g. see Eq. (1). These velocities do not produce a significant pressure drop through the screen openings, thus minimizing fish impingement.

Microbiology:

Unique to the process embodied herein, are the additional steps of controlling the indigenous microbiology to produce a viable, sustainable product. The first step involves the control of the indigenous microbiology which, in most cases, is harmless to the environment and may, in some cases, be beneficial; it is nevertheless inconsistent on both counts.

In order to remove the indigenous bacteria from consideration, the wastewater is held in the solids reservoir 36, transferred by use of a transfer pump 38 or gravity flow to a raw water reservoir 40 where it then is decontaminated. Any method can be used for the decontamination process, for example, so as to create extreme temperatures or pressures to kill any microbiology, including spores. For example, pasteurization, microwaving, heating, filtration, irradiation (e.g. gamma irradiation), gassing (e.g. ethylene oxide), injecting steam, pressurizing, applying electrical energy directly to the admixture, or one or more any combinations thereof. For example, in an embodiment wherein extreme pasteurization is utilized, the waste water is flash heated up to about 185 degrees Fahrenheit (F) for less than about a minute within the decontamination system 42. Any of the parameters can be varied, e.g. heating temperatures, amount of time the fluid is heated, etc. In the case of milk, for example, pasteurization does not kill all the microbiology, but suppresses the viable population because it is done at lower temperatures and holding times. It is well known that higher temperatures and hold times causes the deterioration of the proteins and affects taste and flavor in milk. In the case of the soil enhancement platform material there is no real concern for taste or flavor, so some degradation of the proteins is very acceptable and even desirable. The higher temperatures effectively kill all indigenous microbiology, rendering the material an ideal environment to grow a specific microbiology to a desired concentration and thereby transform the material into a controlled soil enhancement substance which may be applied in a repeatable, specific manner to achieve desired results.

The combined mixture is flash heated to a temperature between about 145-185 degrees Fahrenheit and held for a period of time between about 20-60 seconds before being immediately cooled in heat recovery equipment within the decontaminating system 42 to a temperature below 100 degrees Fahrenheit where it is then stored in tanks 44. The present invention may include the addition of a formula of naturally occurring bacteria from the genus Bacillus selected specifically for their ability to work symbiotically with each other and the particular plants where it will be applied to the decontaminated admixture. The decontaminated admixture is held for a period of time to allow the added formula to achieve a desired concentration at or before actual application such that the microbial formulation is at appropriate concentration and in state so it will work immediately upon application. The specific volume and microbial concentration of the formula added to the decontaminated admixture is determined by consulting a table, pertaining to the predetermined growth rates of these formula in decontaminated mixtures tested to achieve a desired concentration of the specific microbial formulation mentioned.

In an embodiment, the fish are fed a natural feed formulation that is certified organic and high in protein. Because food is the single largest expense in fish farming, it is common for the fish to be fed inexpensive feed which is typically high in carbohydrates. In the embodied process, the natural formulation provides a consistent feed conversion rate which, in turn, produces consistent fecal composition amounts and consistent indigenous fecal microbiology. Using this type of formulation, the fish have an extremely high feed conversion rate resulting in both lower fecal production and more consistent indigenous microbiology and an almost non-existent mortality rate. The result is minimal food left in the water as the higher quality food is consumed and primarily converts into healthy fish growth.

In order for the organic constituents, nutrients and micro-nutrients resulting from the fish farming process to be used to enhance plant health, growth, resistance to pests and disease, sampling of the combined mixture and testing for COD, Total Nitrogen, Total Phosphorous, Total Potassium and presence of pathogens is conducted. This information is then used to adjust the composition to acceptable values by blending as previously mentioned.

It is well known that adding certain microbiology to soil is beneficial in many ways and this is especially true for microbiology commonly found in soil such as that from genus Bacillus. Many companies offer various formulations of spore state microbes, as well as fungi, in a wide variety of concentrations for dilution and application to soil. Indeed some companies even offer packets of formula, together with nutrients, to be added to water in a tank and thereby allowed to grow to some concentration over a prescribed period of time prior to application, either directly or indirectly via dilution with water in either a mobile sprayer or fixed irrigation process. The limitations of diluting fixed concentrations is a combination of high cost for those containing only spores, as well as shelf life for those containing microbial and fungal species, either alone or in combination with spores.

The limitations on those offerings claiming to grow bacteria from prepackaged formula containing food and nutrients are similar. Overall this restricts that application rate (number of microbes per unit surface area) in general, and the bacteria quickly deplete the available food and nutrients. Additionally, if there are insufficient food and nutrients in the soil to sustain the added microbiology, the added microbiology does not have the opportunity to thrive in the new environment. It is well known in the literature that moving microbiology from one environment to another can create what is termed a “shock” condition where reproduction is hindered or suspended. Therefore, it is extremely difficult to apply a sufficient population to the soil to truly change the microbiological makeup and, of equal importance, sustain that change to the benefit of the plants. Multiple applications of high counts of desirable bacteria allow the microbiological makeup to shift to more beneficial organisms and possibly out compete pathogens.

### EXAMPLES

### Example 1

### Trial Watermelons: Drip Irrigation Under Raised Plastic Covered Beds (Johnson Farms, Wauchula Fla.)

Trial Date: Dec. 29, 2013

Application Rates: 10/7.5/5/2.5/2.5 gallons of N.E.W. Plus Microorganisms per acre.

Florida ranks second in the United States in acreage and value of fresh market vegetables with almost 290,000 acres in production [U.S. Department of Agriculture (USDA), 2012] and over $2 billion in farm gate value. Florida is also a leader in watermelon production, ranking first during 2012 among the top five leading states in the country along with Texas, California, Georgia, and Arizona for production and value [U.S. Department of Agriculture (USDA), 2012]. Watermelon production is concentrated in southern Florida where many growers use seepage or drip irrigation with or without raised beds.

The study was conducted during the winter-to-spring growing seasons of 2013 and 2014 and was located at Johnson Farms in Wauchula Fla. This study evaluated 5 weekly applications of N.E.W. plus microorganisms with the initial application starting 2 weeks after transplant at 10 gallons per acre and subsequent weekly applications reduced by 2.5 gallons per acre per week for the following 4 weeks.

Results:

Yield increase of 17 percent and 2 week early maturity over untreated control.

### Example 2

### Heritage Palms Golf Course Trial A

Trial Date: Apr. 29, 2014.

Trial Size: 4 Acres Fairway.

Application Rates: 33 gallons/acre of N.E.W. Plus Microorganisms per acre, every 14 days.

Trial still under way, quicker recovery noted on treated fairway after aeration and verticutting. NDVI “greenness” readings are consistently higher.

### Example 3

### Heritage Palms Golf Course Trial B

Trial Date: Aug. 7, 2014.

Trial Size: Putting Green.

Application Rates: 33 gallons/acre of N.E.W. Plus Microorganisms per acre, every 14 days.

No data yet collected for nematode management properties at present.

### Example 4

### Pelican Preserve Golf Course Trial

Trial Date: Apr. 29, 2014

Trial Size: 4 Acres Fairway

Application Rates: 33 gallons/acre of N.E.W. Plus Microorganisms per acre, every 14 days.

Trial still under way, quicker recovery noted on treated fairway after aeration and verticutting. NDVI “greenness” readings are consistently higher.

### Example 5

### El Rio Golf Course Trial A

Trial Date: Apr. 30, 2014.

Trial Size: 2.5 Acres Fairway.

Application Rates: 33 gallons/acre of N.E.W. Plus Microorganisms per acre, every 14 days.

Trial still under way, quicker recovery noted on treated fairway after aeration and verticutting. NDVI “greenness” readings are consistently higher.

### Example 5

### El Rio Golf Course Trial B

Trial Date: Apr. 30, 2014.

Trial Size: Nursery Green.

Application Rates: 33 gallons/acre of N.E.W. Plus Microorganisms per acre, every 14 days.

No data yet collected for nematode management properties.

### Example 6

### Jet Blue Park Recreation Turf Grass Trial

Trial Date: Aug. 20, 2014.

Trial Size: 7 acres Turf Grass.

Application Rates: 33 gallons/acre of N.E.W. Plus Microorganisms per acre, every 14 days.

Good recovery on treated area, this recreational field site is used 7 days per week and healed faster than treated area along with recovering quicker after damage.

### Example 7

### Trial Mature Citrus Grove: Drip Irrigation

Location: Smoak Cemetery Grove, Lake Placid Fla.

Trial Date: Sep. 9, 2014.

Application Rates: 25/15/7.5/5/2.5 gallons of N.E.W. Plus Microorganisms per acre.

Comparison against Vydate (DuPont), results still to be obtained.

### Example 8

### Trial Mature Citrus Grove: Drip Irrigation

Location: Serena Groves, Lake Placid Fla.

Trial Date: Jun. 24, 2014

Application Rates: 10/7.5/5/2.5/2.5 gallons of N.E.W. Plus Microorganisms per acre.

Trial still underway, this is a trial to extend the life/viability of older trees severely infected with greening.

### Example 9

### Trial Mature Citrus Grove: Drip Irrigation

Location: Old Lorida, Lake Placid Fla.

Trial Date: Aug. 26, 2014.

Application Rates: 10/7.5/5/2.5/2.5 gallons of N.E.W. Plus Microorganisms per acre.

Trial still underway, this is a trial to extend the life/viability of older trees moderately infected with greening.

### Example 10

### Trial Newly Planted Young Citrus Grove: Drip Irrigation

Lake Placid Growers, Lake Placid Fla.

Trial Date: Aug. 26, 2014.

Application Rates: 10/7.5/5/2.5/2.5 gallons of N.E.W. Plus Microorganisms per acre.

Trial still underway, this is a newly planted young block that should be a good indicator of young tree's and the effect of N.E.W.

### Example 11

### Trial Blueberry's: Drip irrigation

Location: Sandy Ridge Blueberry's, Wauchula Fla.

Trial Date: Aug. 26, 2014.

Application Rates: 10/7.5/5/2.5/2.5 gallons of N.E.W. Plus Microorganisms per acre.

Results: Expected to increase yield in previously unproductive blocks of blueberries.

While a detailed embodiment of the instant invention is disclosed herein, it is to be understood that the disclosed embodiments are merely exemplary of the invention, which may be embodied in various forms and include most any radius form. Therefore, specific functional and structural details disclosed herein are not to be interpreted as limiting, but merely as a basis for the claims and as a representation basis for teaching one skilled in the art to variously employ the present invention in virtually any appropriately detailed structure.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method of producing a soil enhancement material comprising the steps of:
placing one or more aquatic species into at least one growing tank containing fluid;
feeding said one or more aquatic species a formulation that is high in protein and capable of forming consistent indigenous fecal microbiology;
passing said fluid from said growing tank through a filter for removal of suspended particulate;
directing said suspended particulate matter to a particulate reservoir holding tank and the remaining fluid to a filtered reservoir tank;
mixing a predetermined portion of water from said grow tank with said suspended particulate held in said filtered reservoir tank to form an admixture;
sampling of the admixture for COD, Total Nitrogen, Total Phosphorous, Total Potassium and presence of pathogens;
adjusting the admixture to an acceptable value by blending additional filtered fluid or other materials or additives which are further conducive to growth of any added microbiology and/or plants;
decontaminating said admixture and placing into a container for shipping and distribution;
recirculating remaining fluid from said filtered reservoir tank to said grow tank.

2. The method of producing a soil enhancement material according to claim 1 wherein said filter separates and removes a biomass of solids, semisolids and/or some dissolved solids from the fluid.

3. The method of producing a soil enhancement material according to claim 1 including the step of decontaminating said soil enhancement material, the step of decontaminating comprising: pasteurization, microwaving, heating, filtration, irradiation, gassing, injecting steam, pressurizing, applying electrical energy or any combinations thereof.

4. The method of producing a soil enhancement material according to claim 3, wherein the step of decontaminating said admixture by pasteurization comprises wherein flash heating of said admixture from between about 145-185 degrees Fahrenheit (F) for less than minute before being immediately cooled in heat recovery unit to less than about 100 degrees Fahrenheit.

5. The method of producing a soil enhancement material according to claim 1 including the steps of:
degassing said filtered fluid reservoir to remove volatile materials including ammonia;
passing said degassed fluid through a bio-filter containing a high surface area media to further break down suspended and dissolved organic compounds through a process of microbiological nitrification/denitrification.

6. The method of producing a soil enhancement material according to claim 5 optionally including the step of providing enriched oxygen, having at least about 80%, 85%, 90% or more of total oxygen volume/volume (v/v) from an oxygen generator.

7. The method of producing a soil enhancement material according to claim 1 wherein said grow tank is circulated at a rate where the entire volume of said tank is replaced from about every one (1) to about six (6) hours.

8. The method of producing a soil enhancement platform material according to claim 1 wherein said high protein formulation is a natural organic or certified organic fish food.

9. The method of producing a soil enhancement material according to claim 8 wherein said organic formulation is a certified organic production whereby said aquatic farm meets certified organic production requirements.

10. A method of producing a soil enhancement material for use in growing fruits, vegetables, crops, or turf grass that meet certified organic production requirements comprising the steps of:
placing farm fish into at least one growing tank containing fluid;
feeding said farm fish a certified natural organic formulation that is high in protein and capable of forming consistent indigenous fecal microbiology;
passing said fluid from said growing tank through a filter for removal of suspended particulate, said filter separates and removes a biomass of solids, semisolids and/or some dissolved solids from the fluid;
directing said suspended particulate matter to a particulate reservoir holding tank and the remaining fluid to a filtered reservoir tank;
mixing a predetermined portion of water from said grow tank with said suspended particulate held in said filtered reservoir tank to form an admixture;
sampling of the admixture for COD, Total Nitrogen, Total Phosphorous, Total Potassium and presence of pathogens;
adjusting the admixture to an acceptable value by blending addition filtered fluid or other materials or additives which are further conducive to growth of any added microbiology and/or plants;
decontaminating said admixture;
placing said admixture onto roots of fruits, vegetables, crops or turf grass.

11. The method of producing a soil enhancement material according to claim 1 including the step of decontaminating said admixture comprising: pasteurization, microwaving, heating, filtration, irradiation, gassing, injecting steam, pressurizing, applying electrical energy or any combinations thereof.

12. The method of producing a soil enhancement material according to claim 11, wherein the step of decontaminating said admixture by pasteurization comprises wherein flash heating of said admixture from between about 145-185 degrees Fahrenheit (F) for less than minute before being immediately cooled in heat recovery unit to less than about 100 degrees Fahrenheit.

13. The method of producing a soil enhancement material according to claim 10 wherein said soil enhancement platform material meets certified organic production requirements.

14. A system for cultivating aquatic species or for producing a soil enhancement material comprising a plurality of tanks, wherein the tanks comprise at least one grow tank, an optional transfer pump or gravity flow for use in passing water through a filter for removal of suspended particulate matter to a filtered reservoir holding tank.

15. The system of claim 14, wherein one or more filters separate and remove a biomass, comprised of solids, semisolids and/or some dissolved solids from the water of the system as fluid passes through the one or more filters.

16. The system of claim 15, wherein the one or more filters, filter the biomass, which is backwashed from the filter using dechlorinated potable water, or from the continuously circulated aquatic organism farming water and directs the biomass to a continuously mixed solids reservoir which is mixed with a predetermined portion of water from the grow tanks and held for further processing.

17. The system of claim 15, wherein one or more filtered water reservoir tanks provide flow consistency with one or more transfer pumps or by gravity flow for introducing the filtered water into a degassing apparatus.

18. The system of claim 17, wherein the fluid is directed to a degassing apparatus for removing volatile materials including ammonia and a bio-filter reservoir containing a high surface area media to further break down suspended and dissolved organic compounds through a microbiological nitrification/denitrification process from the water.

19. The system of claim 15, wherein dechlorinated potable water is added to makeup water lost in filtration, blending, and evaporation.

20. The system of claim 15, wherein filtration of the water filters out most particulate matter having a size or diameter of at least about 5 μm or less.

21. The system of claim 15, optionally comprising adding enriched oxygen from an oxygen generator.

22. The system of claim 15, wherein a target dissolved oxygen levels in the tanks are about 6 mg/l or higher of oxygen.

23. The system of claim 15, wherein the fluid in the at least one or more tanks is circulated at a rate such that the entire volume of each tank is replaced every one to six hours, depending upon the growth state of the animals inside the tank.
